(19) United States
(12) Patent Application Publication
(10) Pub. No.: US 2026/0025477 A1
(43) Pub. Date: Jan. 22, 2026

(54) MOVABLE TV AND CONTROL METHOD THEREOF

(71) Applicant: LG ELECTRONICS INC., Seoul (KR)

(72) Inventors: Sungeun KIM, Seoul (KR); Donghee LEE, Seoul (KR)

(73) Assignee: LG ELECTRONICS INC., Seoul (KR)

(21) Appl. No.: 19/106,751

(22) PCT Filed: Aug. 26, 2022
(86) PCT No.: PCT/KR2022/012805

§ 371 Date: Feb. 26, 2025

(51) Int. Cl. H04N 5/655; H04N 5/63

(52) U.S. Cl. CPC H04N 5/655; H04N 5/63

(57) ABSTRACT

A control method of a movable TV, according to an embodiment of the present invention, comprises the steps of: recognizing at least one mobile device by a proximity distance sensor attached to a casing; changing a state of the casing to an open at a first time point, when the at least one mobile device is recognized; controlling a display module to face the casing at a second time point; and outputting a message inquiring about a state of connection with the at least one mobile device on the display module.

### TECHNICAL FIELD

The present disclosure relates to a multimedia device, and more particularly, is a technology related to a television (TV) movable via connection with various moving means, for example.

### BACKGROUND

Recently, in multimedia devices such as a mobile phone and a TV, a new form-factor is being discussed. The form-factor refers to a structured form of a product.

The reason why form-factor innovation is emerging as important in a display industry is because of increasing needs of a user for the form-factor that may be used freely and conveniently regardless of a use situation departing from a typical form-factor customized for a specific use environment in the past, resulted from an increase in consumer mobility, convergence between devices, a rapid progress in smartization, and the like.

For example, vertical TVs are expanding, breaking the stereotype that the TVs are viewed horizontally. The vertical TV is a product that allows the user to change a direction of a screen by reflecting characteristics of the Millennials and Gen Z who are accustomed to enjoying content on mobile. The vertical TVs are convenient because a social media or a shopping site image may be viewed easily and comments may be read while watching videos at the same time. In particular, the advantages of the vertical TV are magnified more when the vertical TV is in association with a smartphone via a near-field communication (NFC)-based mirroring function. When watching regular TV programs or movies, the TV may be switched horizontally.

As another example, a rollable TV and a foldable smartphone are similar to each other in that they both use ‘flexible displays’. The flexible display literally means a flexible electronic device. To be flexible, the flexible display must first be thin. A substrate that receives information and converts the same into light must be thin and flexible so that a performance lasts for a long time without damage.

Being flexible means that the flexible display should not be greatly affected even when an impact is applied thereto. While the flexible display is bent or folded, a pressure is continuously applied to a junction. It is necessary to have excellent durability such that the inside is not damaged by such pressure, but also have a property of being easily deformed when the pressure is applied.

The flexible display is implemented based on an OLED, for example. The OLED is a display using an organic light emitting material. the organic material is relatively more flexible than an inorganic material such as a metal. Furthermore, the OLED has a thin substrate and thus is more competitive than other displays. In a case of an LCD substrate used in the past, there is a limit to reducing a thickness because liquid crystal and glass are required separately.

Finally, as a new form-factor for the TV, a demand for a TV that may be easily moved indoors and outdoors is increasing. In particular, because of the recent corona virus epidemic, the time the users stay at home is increasing, and thus, a demand for a second TV is increasing. In addition, because of an increase in population going out for camping or the like, there is a demand for the TV of the new form-factor that may be easily carried and moved.

### DISCLOSURE OF THE INVENTION

### Technical Problem

An embodiment of the present disclosure is to present a TV having a new type of form-factor.

Another embodiment of the present disclosure is to provide a TV that is easily movable indoors and outdoors.

Still another embodiment of the present disclosure is to provide a movable TV that enhances usability in connection with a mobile phone or the like, and solves a problem of product damage that may occur when the movable TV and the mobile phone come into physical contact with each other.

### Technical Solutions

A method for controlling a movable TV according to an embodiment of the present disclosure includes recognizing at least one mobile device by a proximity sensor attached to a casing, changing a state of the casing to an open state at a first time point when the at least one mobile device is recognized, controlling a display module to face the casing at a second time point, and outputting a message inquiring about a state of connection with the at least one mobile device on the display module.

The second time point arrives after the first time point. In addition, the proximity sensor operates, for example, by near field communication (NFC).

In addition, a state of controlling the display module to face the casing includes, for example, a state having an angle formed by the display module and the casing of 180 degrees.

A method for controlling a movable TV according to another embodiment of the present disclosure further includes receiving a power-off signal while the at least one mobile device is being charged via the TV, and setting a lock for a motion of the casing.

A method for controlling a movable TV according to still another embodiment of the present disclosure further includes receiving a power-off signal while the at least one mobile device is in contact with the display module, and outputting a guide voice via a speaker installed in the casing.

A method for controlling a movable TV according to yet another embodiment of the present disclosure further includes, when the mobile device includes a plurality of mobile devices, outputting a screen identical to a screen of a first mobile device on the display module, and outputting only a specific event that occurred in a second mobile device on a partial area of the display module.

A TV capable of being packaged by a casing according to an embodiment of the present disclosure includes a proximity sensor that is attached to the casing and recognizes at least one mobile device, a controller that changes a state of the casing to an open state at a first time point and controls a display module to face the casing at a second time point when the at least one mobile device is recognized, the display module, and the like.

Particularly, the controller controls a message inquiring about a state of connection with the at least one mobile device to be output on the display module.

### Advantageous Effects

According to an embodiment of the present disclosure, the TV having the new type of form-factor is presented.

According to another embodiment of the present disclosure, the TV that is easily movable indoors and outdoors is provided.

Further, according to still another embodiment of the present disclosure, convenience of connecting the movable TV with the mobile phone or the like may be enhanced, and the problem of product damage that may occur when the movable TV and the mobile phone come into physical contact with each other may be prevented in advance.

A further scope of applicability of the present disclosure will become apparent from the detailed description below.

However, because various changes and modifications within the spirit and the scope of the present disclosure may be clearly understood by those skilled in the art, the detailed description and specific embodiments such as preferred embodiments of the present disclosure should be understood as given only as examples.

### BRIEF DESCRIPTION OF THE DRAWINGS

FIGS. 1 to 11 are diagrams for illustrating a display device according to an embodiment of the present disclosure.

FIG. 12 is a block diagram for illustrating each component of a display device according to an embodiment of the present disclosure.

FIG. 13 is a diagram showing a display device according to an embodiment of the present disclosure.

FIG. 14 is a diagram showing an example of utilization of a display device according to an embodiment of the present disclosure.

FIG. 15 is another diagram showing an example of utilization of a display device according to an embodiment of the present disclosure.

FIG. 16 is a diagram showing front and side surfaces of a display device according to an embodiment of the present disclosure.

FIG. 17 illustrates a speaker mode and a video mode provided by a movable TV according to an embodiment of the present disclosure.

FIG. 18 illustrates a process in which a casing of a movable TV is automatically opened when a mobile device touches a first location, which is a specific location of the movable TV, according to an embodiment of the present disclosure.

FIG. 19 illustrates a plurality of options provided by a movable TV when the movable TV according to an embodiment of the present disclosure and a mobile device come into contact with each other at a second location.

FIG. 20 is a view for illustrating a process for processing a power-off signal when a mobile device is being charged while a movable TV according to an embodiment of the present disclosure is in a video mode.

FIG. 21 is a view for illustrating a process of processing a power-off signal when a mobile device is mounted while a movable TV according to an embodiment of the present disclosure is in a speaker mode.

FIG. 22 is a view for illustrating a process of processing data received from mobile devices based on a priority or the like in a state in which a movable TV according to an embodiment of the present disclosure is in communication with the plurality of mobile devices.

Further, FIG. 23 is a flowchart illustrating a method for controlling a movable TV according to an embodiment of the present disclosure.

### BEST MODE

Hereinafter, the embodiments disclosed herein will be described in detail with reference to the accompanying drawings, but components that are the same as or similar to each other regardless of reference numerals will be given the same reference numerals, and redundant description thereof will be omitted. The suffixes “module” and “unit” for components used in the following description are given or used together in consideration of ease of writing the present document, and do not have meanings or roles that are distinct from each other by themselves. Further, in describing the embodiments disclosed herein, when it is determined that a detailed description of related known technologies may unnecessarily obscure the gist of the embodiments disclosed herein, detailed description thereof will be omitted. In addition, the attached drawings are provided for easy understanding of the embodiments disclosed herein and do not limit technical idea disclosed herein, and should be construed as including all modifications, equivalents, and alternatives falling within the spirit and scope of the present disclosure.

Although terms including ordinal numbers, such as first, second, and the like, may be used to describe various components, the components are not be limited by the terms. The terms are only used to distinguish one component from another.

It should be understood that when a component is referred to as being “connected with” another component, the component may be directly connected with another component or an intervening component may also be present. In contrast, it should be understood that when a component is referred to as being “directly connected with” another component, there is no intervening component present.

A singular representation may include a plural representation unless it represents a definitely different meaning from the context.

The terms “includes” or “has” used herein should be understood as not precluding possibility of existence or addition of one or more other characteristics, figures, steps, operations, constituents, components, or combinations thereof.

Direction indications of up U, down D, left Le, right Ri, front F, and rear R shown in the drawings are only for convenience of description, and thus, the technical idea disclosed herein is not limited.

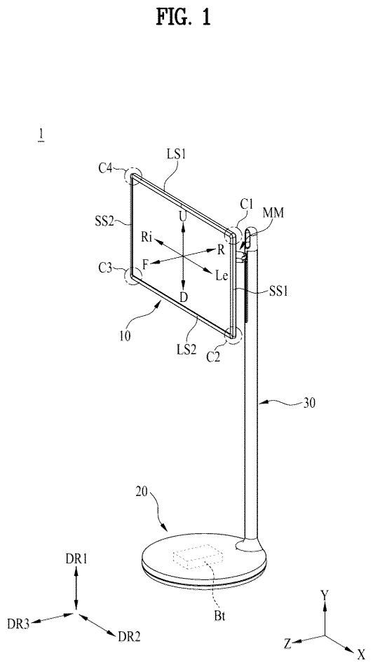

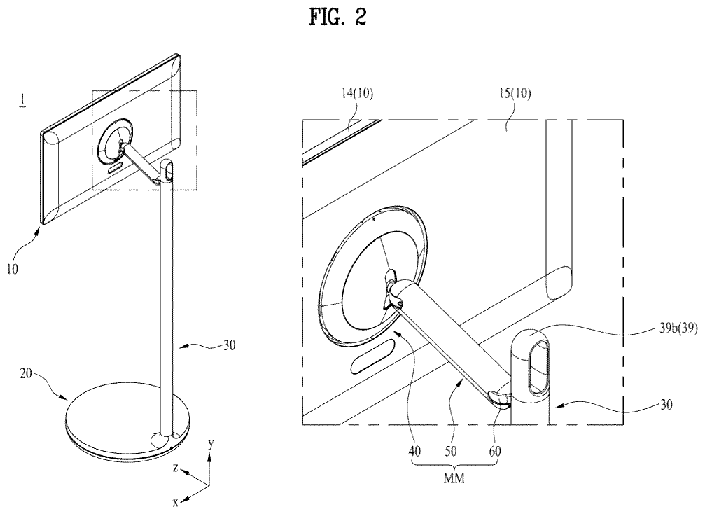

FIGS. 1 to 11 are diagrams for illustrating a display device according to an embodiment of the present disclosure.

Referring to FIG. 1, a display device 1 may include a head 10. The head 10 may display an image. The head 10 may be referred to as a display 10 or a display unit 10.

The head 10 may include a first long side LS1, a second long side LS2 opposite to the first long side LS1, a first short side SS1 adjacent to the first long side LS1 and the second long side LS2, and a second short side SS2 opposite to the first short side SS1. Although it is shown and described that a length of the first and second long sides LS1 and LS2 is greater than a length of the first and second short sides SS1 and SS2 for convenience of illustration, the length of the first and second long sides LS1 and LS2 may be approximately equal to the length of the first and second short sides SS1 and SS2.

A direction parallel to the short sides SS1 and SS2 of the head 10 may be referred to as a first direction DR1 or a vertical direction. A direction parallel to the long sides LS1 and LS2 of the head 10 may be referred to as a second direction DR2 or a left and right direction. A direction perpendicular to the long sides LS1 and LS2 and the short sides SS1 and SS2 of the head 10 may be referred to as a third direction DR3 or a front and rear direction.

A side on which the head 10 displays the image may be referred to as the front side F and z, and a side opposite thereto may be referred to as the rear side R. A side of the first short side SS1 may be referred to as the left side Le and x. A side of the second short side SS2 may be referred to as the right side Ri. A side of the first long side LS1 may be referred to as the upper side U and y. A side of the second long side LS2 may be referred to as the lower side D.

The first long side LS1, the second long side LS2, the first short side SS1, and the second short side SS2 may be referred to as edges of the head 10. In addition, a point where two of the first long side LS1, the second long side LS2, the first short side SS1, and the second short side SS2 meet each other may be referred to as a corner.

A point where the first short side SS1 and the first long side LS1 meet each other may be a first corner C1. A point where the first short side SS1 and the second long side LS2 meet may be a second corner C2.

A point where the second short side SS2 and the second long side LS2 meet each other may be a third corner C3. A point where the second short side SS2 and the first long side LS1 meet each other may be a fourth corner C4.

Referring to FIGS. 1 and 2, the display device 1 may include a base 20, a pole 30, and a motion module MM.

The base 20 may have a flat cylinder shape as a whole. The base 20 may be disposed on the ground.

The pole 30 may extend long in the vertical direction. A lower end of the pole 30 may be coupled onto the base 20. The pole 30 may be adjacent to a circumference of a top surface of the base 20. A handle 39 may be coupled to an upper end of the pole 30. The pole 30 and the aforementioned base 20 may be collectively referred to as a stand.

The motion module MM may extend in a direction intersecting the pole 30. One side of the motion module MM may be coupled to a rear side of the head 10. The other side of the motion module MM may be adjacent to the upper end of the pole 30 and may be coupled to the pole 30. An articulating connector 40 may be coupled to the rear side of the head 10, an elevating module 60 may be coupled to the pole 30, and an arm 50 may connect the articulating connector 40 and the elevating module 60 to each other.

Accordingly, the head 10 may be supported by the motion module MM, the pole 30, and the base 20, and may be spaced upward from the ground.

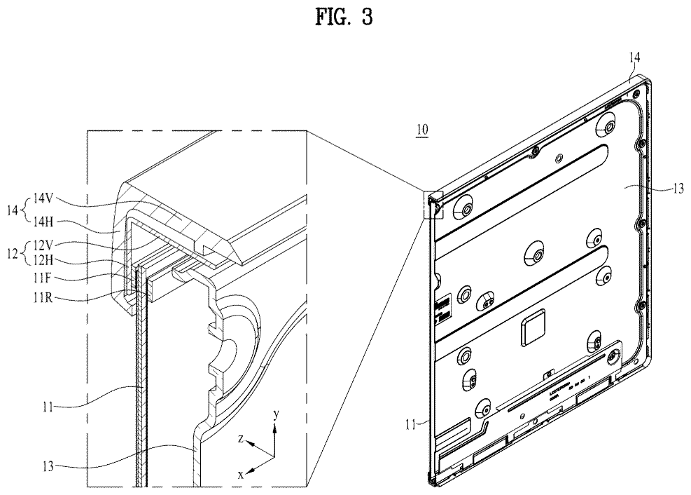

Referring to FIGS. 2 and 3, the head 10 may include a display panel 11, a middle cabinet 12, a frame 13, an end frame 14, and a back cover 15.

The display panel 11 may form a front surface of the head 10. For example, the display panel 11 may be an OLED panel, an LCD panel, or an LED panel. The display panel 11 may output the image by dividing the image into a plurality of pixels and matching color, brightness, and saturation for each pixel. The display panel 11 may be divided into an active area in which the image is displayed and an inactive area in which the image is not displayed. The display panel 11 may generate light with a color corresponding to red, green, or blue in response to a control signal.

The middle cabinet 12 may extend along a perimeter of the display panel 11. A horizontal portion 12H may be located in front of the display panel 11. A vertical portion 12V may intersect the horizontal portion 12H and may cover a side surface of the display panel 11.

For example, the middle cabinet 12 may contain a metal or plastic material. The middle cabinet 12 may be referred to as a side frame or a guide panel.

The frame 13 may be positioned at the rear of the display panel 11. Electronic components such as a printed circuit board (PCB) may be coupled to a rear surface of the frame 13. For example, the frame 13 may contain a metal material. The frame 13 may be referred to as a mount plate or a module cover.

The end frame 14 may form a perimeter of the head 10. A horizontal portion 14H may be located in front of the horizontal portion 12V of the middle cabinet 12. A vertical portion 14V may cover a side surface of the vertical portion 12V of the middle cabinet 12. For example, the end frame 14 may contain a metal or plastic material.

The back cover 15 may form a rear surface of the head 10. The back cover 15 may cover the frame 13 from the rear and may be coupled to the frame 13.

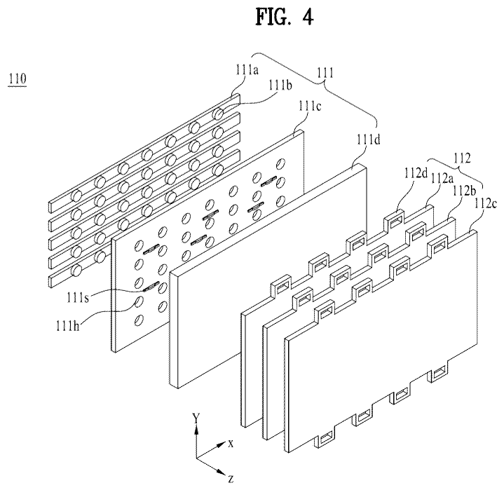

Referring to FIGS. 3 and 4, a backlight unit 110 may be positioned between the display panel 11 and the frame 13 and coupled to the frame 13. In this regard, the display panel 11 may be referred to as the LCD panel. The backlight unit 110 may include an optical layer 111 and an optical sheet 112. The optical layer 111 may include a substrate 111a, at least one light source 111b, a reflective sheet 111c, and a diffusion plate 111d.

The substrate 111a may be coupled to a front surface of the frame 13. The substrate 111a may have a plate shape or may be composed of a plurality of straps spaced apart from each other in the vertical direction. The at least one light source 111b may be mounted on the substrate 111a. For example, the light source 111b may include a light emitting diode (LED). An electrode pattern for connecting an adapter and the light source 111b to each other may be formed on the substrate 111a. The reflective sheet 111c may be positioned in front of the substrate 111a. The reflective sheet 111c may have a hole 111h in which the light source 111b is positioned. The diffusion plate 111d may be positioned in front of the reflective sheet 111c. A spacer 111s may support a rear surface of the diffusion plate 111d at a location between the reflective sheet 111c and the diffusion plate 111d.

The optical sheet 112 may be located in front of the diffusion plate 111d. A rear surface of the optical sheet 112 may be in close contact with the diffusion plate 111d, and a front surface of the optical sheet 112 may be in close contact with or adjacent to a rear surface of the display panel 11. The optical sheet 112 may include at least one of a diffusion sheet and a prism sheet. A coupling portion 112d may be formed at at least one edge of the optical sheet 112.

Accordingly, light from the light source 111b may be provided to the display panel 11 through the diffusion plate 111d and the optical sheet 112. In one example, the display panel 11 of the present disclosure may be the OLED panel that does not require the aforementioned backlight unit 110 or a different type of panel.

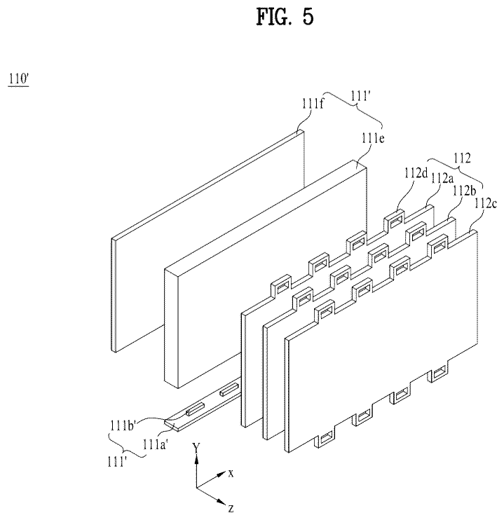

Referring to FIGS. 3 and 5, a backlight unit 110′ may be located between the display panel 11 and the frame 13 and may be coupled to the frame 13. In this regard, the display panel 11 may be referred to as the LCD panel. The backlight unit 110′ may include an optical layer 111′ and the optical sheet 112. The optical layer 111′ may include a substrate 111a′, at least one light source 111b′, a reflective sheet 111f, and a light guide plate 111e. The light guide plate 111e may be positioned between the frame 13 and the optical sheet 112 and may be supported by the frame 13.

The substrate 111a′ may be adjacent to a perimeter of the light guide plate 111e and may be coupled to the frame 13. The at least one light source 111b′ may be mounted on the substrate 111a′. For example, the light source 111b′ may include a light emitting diode (LED). An electrode pattern for connecting an adapter and the light source 111b′ to each other may be formed on the substrate 111a′. The reflective sheet 111f may be positioned between the frame 13 and the light guide plate 111e and may be supported by the frame 13.

Accordingly, light from the light source 111b′ may be provided to the display panel 11 through the light guide plate 111e and the optical sheet 112. In one example, the display panel 11 of the present disclosure may be the OLED panel that does not require the aforementioned backlight unit 110′ or another type of panel.

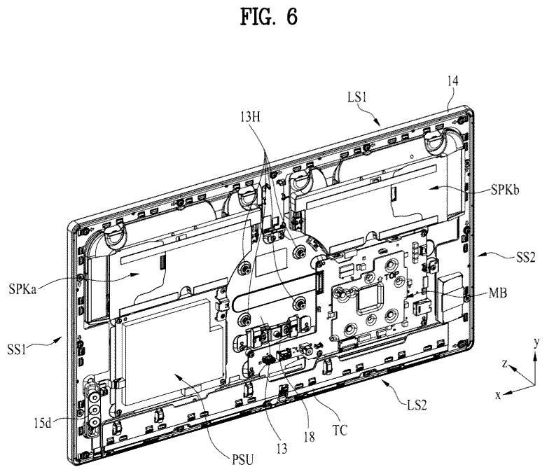

Referring to FIG. 6, the electronic components may be mounted on the rear surface of the frame 13 and may include a plurality of boards PSU, MB, and TC and speakers SPKa and SPKb.

The power supply board PSU may be located closer to the first short side SS1 than to the second short side SS2, and may be coupled to the rear surface of frame 13. The power supply board PSU may provide power to each component of the display device. For example, the power supply board PSU may provide the power to the light sources 111b and 111b′ of the backlight units 110 and 110′ (see FIGS. 4 and 5). The power supply board PSU may be referred to as an LED driver.

The main board MB may be located closer to the second short side SS2 than to the first short side SS1, and may be coupled to the rear surface of the frame 13. The main board MB may control the display device.

The timing controller board TC may be located downwardly of the power supply board PSU and the main board MB, and may be coupled to the rear surface of the frame 13. The timing controller board TC may be electrically connected to the display panel 11 (see FIG. 3) via a cable (not shown) and may provide an image signal to the display panel 11.

The speakers SPKa and SPKb may be located upwardly of the plurality of boards PSU, MB, and TC, and may be coupled to the rear surface of the frame 13. For example, the left speaker SPKa may be located closer to the first short side SS1 than to the second short side SS2, and may provide sound to the side. For example, the right speaker SPKb may be located closer to the second short side SS2 than to the first short side SS1, and may provide sound to the side.

A locking unit 18 may be coupled to the rear surface of the frame 13. The locking unit 18 may be located downwardly of a center of the frame 13.

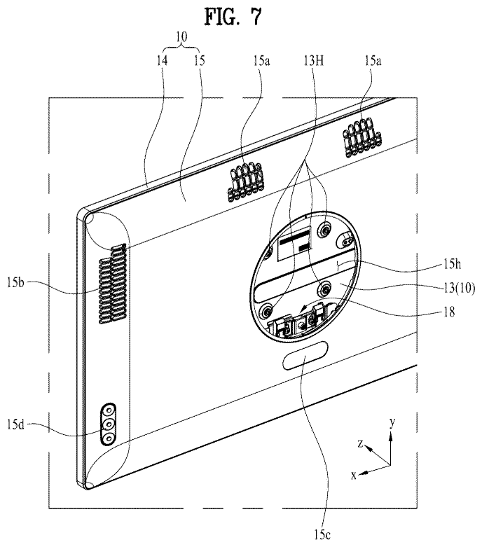

Referring to FIG. 7, the back cover 15 may cover the frame 13 from the rear and may be coupled to the frame 13. Locations of speaker holes 15a and 15b defined in the back cover 15 may correspond to the locations of the speakers SPKa and SPKb (see FIG. 6) mounted on the frame 13.

A fixing member 13H may protrude rearwards from the rear surface of the frame 13. The fixing member 13H may be a fem nut. The fixing member 13H and the locking unit 18 may be exposed to the outside via a hole 15h defined at a center of the back cover 15.

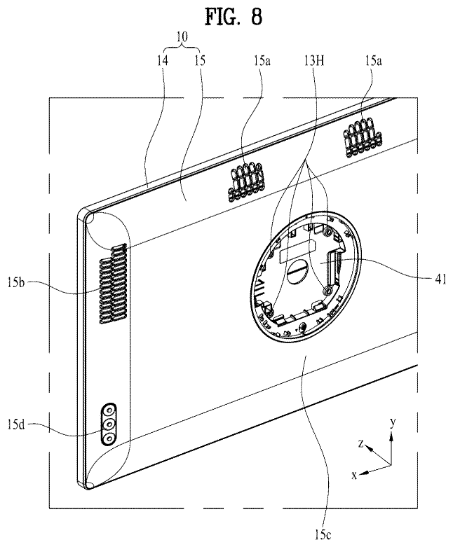

Referring to FIGS. 7 and 8, a fixing plate 41 may have a circular plate shape corresponding to the hole 15h of the back cover 15.

A fixing hole 41H may be defined in the fixing plate 41 and may be aligned with the fixing member 13H. A fastening member (not shown) such as a screw may be fastened to the fixing member 13H via the fixing hole 41H. Accordingly, the fixing plate 41 may be coupled to the frame 13.

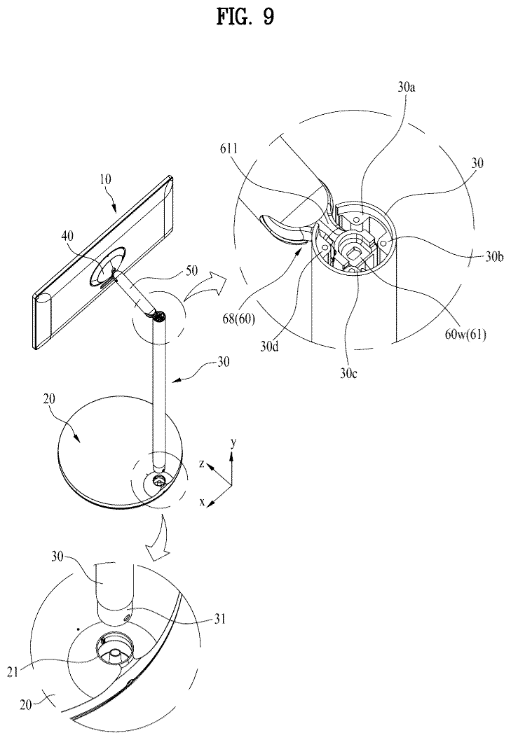

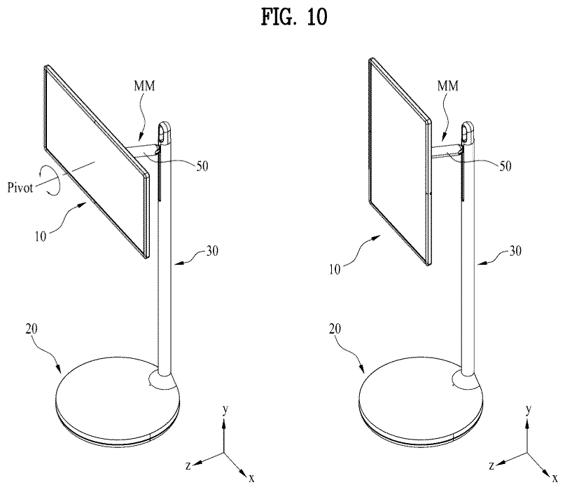

Referring to FIG. 9, the arm 50 may extend in a direction intersecting the head 10 and the pole 30. The arm 50 may connect the articulated connector 40 and the elevating module 60 to each other. A second pivoting unit 68 and a vertical member 61 of the elevating module 60 may be connected to each other via a second connector 611. The second connector 611 may pass through the pole 30.

The vertical portion member 61 may extend in a longitudinal direction of the pole 30. The vertical portion material 61 may be accommodated inside the pole 30.

The pole 30 may extend in the vertical direction and may surround the vertical material 61. A plurality of ribs 30a, 30b, 30c, and 30d may protrude toward the vertical material 61 from an inner circumferential surface of the pole 30, and may be spaced apart from each other in a circumferential direction of the pole 30. The first rib 30a, the second rib 30b, the third rib 30c, and the fourth rib 30d may be positioned at vertices of an arbitrary square inside the pole 30.

In addition, an inserted portion 31 of the pole 30 may be inserted into and coupled to a port 21 defined in a top surface of the base 20.

Referring to FIG. 10, the head 10 may be spaced upward from the base 20. A user may pivot the head 10. A pivot axis may pass through a center of head 10 and may be orthogonal to the head 10. Referring to a left drawing in FIG. 10, the head 10 may be placed in a landscape mode. Referring to a right drawing in FIG. 10, the head 10 may be placed in a portrait mode.

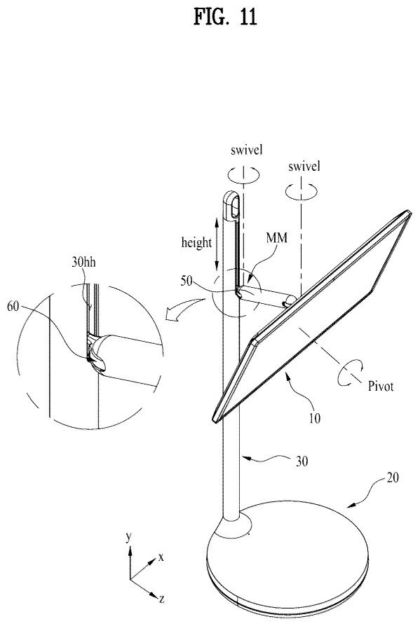

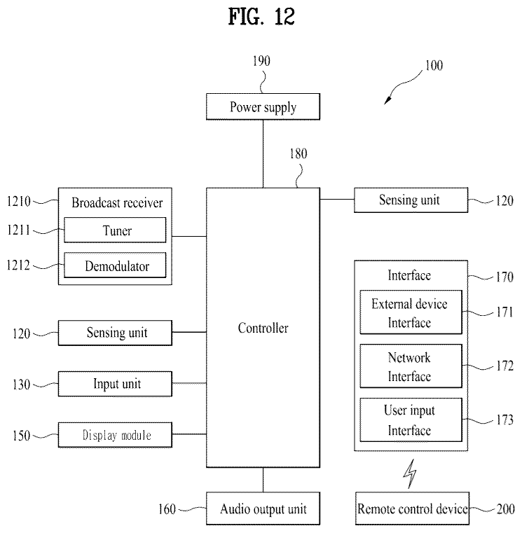

Referring to FIG. 11, the user may tilt the head 10. A tilt axis is located at the rear of the center of the head 10 and may be a horizontal axis parallel to the head 10. The user may swivel the head 10. A first swivel axis may be a vertical axis adjacent to one end of the arm 50. A second swivel axis may be a vertical axis adjacent to the other end of the arm 50. The user may ascend or descend the head 10 from the pole 30.

The aforementioned pivoting, tilting, swiveling, and elevating operations of the head 10 may be implemented independently of each other. For example, the head 10 may be pivoted within a range from +90 degrees to −90 degrees. For example, the head 10 may be tilted within a range from +25 degrees to −25 degrees. For example, the head 10 may be swiveled within a range from +65 to −65 degrees. For example, the head 10 may be located at a vertical level in a range from 1,065 to 1,265 mm from the base 20 or the ground in the landscape mode.

Referring to FIGS. 10 and 11, the base 20 may stably support various motions of the display device via the motion module MM. In addition, the base 20 may improve stability of moving of the display device via a wheel assembly 29 (see FIG. 34).

On the other hand, the display device described herein is, for example, an intelligent display device in which a computer support function is added to a broadcast reception function. The intelligent display device may have a more user-friendly interface such as a handwriting-type input device, a touch screen, or a space remote control as an Internet function is added while being faithful to the broadcast reception function. In addition, the display device may be connected to Internet and a computer as a wired or wireless Internet function is supported, thereby performing functions such as an e-mail, web browsing, banking, or a game. A standardized universal OS may be used for such various functions.

Therefore, because various applications may be freely added to or deleted from the display device described in the present disclosure, for example, a general-purpose OS kernel, various user-friendly functions may be performed. More specifically, the display device may be, for example, a network TV, an HBBTV, a smart TV, and the like, and may also be applied to a smart phone in some cases.

FIG. 12 is a block diagram for illustrating each component of a display device 100 according to an embodiment of the present disclosure.

The display device 100 may include a broadcast receiver 1210, an external device interface 171, a network interface 172, storage 140, a user input interface 173, an input unit 130, and a controller 180, a display module 150, an audio output unit 160, and/or a power supply 190.

The broadcast receiver 1210 may include a tuner 1211 and a demodulator 1212.

Unlike the drawing, the display device 100 may include only the external device interface 171 and the network interface 172 among the broadcast receiver 1210, the external device interface 171, and the network interface 172. That is, the display device 100 may not include the broadcast receiver 1210.

The tuner 1211 may select a broadcast signal corresponding to a channel selected by the user or all pre-stored channels among broadcast signals received via an antenna (not shown) or a cable (not shown). The tuner 1211 may convert the selected broadcast signal into an intermediate-frequency signal or a base band image or audio signal.

For example, when the selected broadcast signal is a digital broadcast signal, the tuner 1211 may convert the digital broadcast signal into a digital IF signal (DIF), and when the selected broadcast signal is an analog broadcast signal, the tuner 1211 may convert the analog broadcast signal into an analog base band image or audio signal (CVBS/SIF). That is, the tuner 1211 may process the digital broadcast signal or the analog broadcast signal. The analog base band image or audio signal (CVBS/SIF) output from the tuner 1211 may be directly input to the controller 180.

In one example, the tuner 1211 may sequentially select broadcast signals of all stored broadcast channels via a channel memory function among the received broadcast signals, and convert the selected signals into the intermediate-frequency signal or the base band image or audio signal.

In one example, the tuner 1211 may include a plurality of tuners to receive broadcast signals of a plurality of channels. Alternatively, the tuner 1211 may be a single tuner that simultaneously receives the broadcast signals of the plurality of channels.

The demodulator 1212 may receive the digital IF signal (DIF) converted by the tuner 1211 and perform a demodulation operation. The demodulator 1212 may output a stream signal (TS) after performing demodulation and channel decoding. In this regard, the stream signal may be a signal in which an image signal, an audio signal, or a data signal is multiplexed.

The stream signal output from the demodulator 1212 may be input to the controller 180. The controller 180 may output an image via the display module 150 and output an audio via the audio output unit 160 after performing demultiplexing, image/audio signal processing, and the like.

A sensing unit 120 refers to a device that senses a change in the display device 100 or an external change. For example, the sensing unit 120 may include at least one of a proximity sensor, an illumination sensor, a touch sensor, an infrared (IR) sensor, an ultrasonic sensor, an optical sensor (e.g., a camera), a voice sensor (e.g., a microphone), a battery gauge, and an environment sensor (e.g., a hygrometer, a thermometer, and the like).

The controller 180 may check a state of the display device 100 based on information collected by the sensing unit 120, and when a problem occurs, the controller 180 may notify the user of the problem or may make adjustments on its own to control the display device 100 to maintain the best state.

In addition, a content, an image quality, a size, and the like of the image provided by the display module 150 may be controlled differently based on a viewer sensed by the sensing unit, a surrounding illumination, or the like to provide an optimal viewing environment. As a smart TV progresses, the number of functions of the display device increases and the number of sensing units 20 also increases together.

The input unit 130 may be disposed at one side of a main body of the display device 100. For example, the input unit 130 may include a touch pad, a physical button, and the like. The input unit 130 may receive various user commands related to an operation of the display device 100 and transmit a control signal corresponding to the input command to the controller 180.

Recently, as a size of a bezel of the display device 100 decreases, the number of display devices 100 in a form in which the input unit 130 in a form of a physical button exposed to the outside is minimized is increasing. Instead, the minimized physical button may be located on a rear surface or a side surface of the display device 100, and a user input may be received from a remote control device 200 via the touch pad or the user input interface 173 to be described later.

The storage 140 may store programs for processing and controlling each signal in the controller 180, or may store signal-processed image, audio, or data signals. For example, the storage 140 may store application programs designed for the purpose of performing various tasks processable by the controller 180, and may selectively provide some of the stored application programs upon request from the controller 180.

The programs stored in the storage 140 are not particularly limited as long as they may be executed by the controller 180. The storage 140 may also perform a function for temporarily storing the image, audio, or data signals received from an external device via the external device interface 171. The storage 140 may store information on a predetermined broadcast channel via the channel memory function such as a channel map.

FIG. 12 shows an embodiment in which the storage 140 is disposed separately from the controller 180, but the scope of the present disclosure is not limited thereto, and the storage 140 is able to be included in the controller 180.

The storage 140 may include at least one of a volatile memory (e.g., a DRAM, a SRAM, a SDRAM, and the like) or a non-volatile memory (e.g., a flash memory, a hard disk drive (HDD), a solid-state drive (SSD), and the like).

The display module 150 may generate a driving signal by converting the image signal, the data signal, an OSD signal, and a control signal processed by the controller 180 or the image signal, the data signal, a control signal, and the like received from the interface 171. The display module 150 may include the display panel 11 having the plurality of pixels.

The plurality of pixels disposed on the display panel may include RGB sub-pixels. Alternatively, the plurality of pixels disposed on the display panel may include RGBW sub-pixels. The display module 150 may generate driving signals for the plurality of pixels by converting the image signal, the data signal, the OSD signal, the control signal, and the like processed by the controller 180.

The display module 150 may be a plasma display panel (PDP), a liquid crystal display (LCD), an organic light emitting diode (OLED), a flexible display module, and the like, or may be a three-dimensional (3D) display module. The 3D display module 150 may be classified into a non-glasses type and a glasses type.

The display device 100 includes the display module that occupies most of the front surface thereof and a casing that covers a rear surface, a side surface, and the like of the display module and packages the display module.

Recently, the display device 100 may use the display module 150 that may be bent such as the light emitting diode (LED) or the organic light emitting diode (OLED) to realize a curved screen in addition to a flat screen.

The LCD, which was mainly used in the past, received light via a backlight unit because it was difficult for the LCD to emit light on its own. The backlight unit is a device that uniformly supplies light supplied from a light source to a liquid crystal located in the front. As the backlight unit became thinner, it was possible to realize a thin LCD, but it was difficult to implement the backlight unit with a flexible material, and when the backlight unit is bent, it was difficult to uniformly supply the light to the liquid crystal, resulting in a change in brightness of the screen.

On the other hand, the LED or the OLED may be implemented to be bendable because each element constituting the pixel emits light on its own and thus the backlight unit is not used. In addition, because each element emits light on its own, even when a positional relationship with a neighboring element changes, brightness thereof is not affected, so that the display module 150 that is bendable using the LED or the OLED may be implemented.

The organic light emitting diode (OLED) panel appeared in earnest in mid-2010 and is rapidly replacing the LCD in a small and medium-sized display market. The OLED is a display made using a self-luminous phenomenon of emitting light when current flows through a fluorescent organic compound. The OLED has a higher image quality response speed than the LCD, so that there is almost no afterimage when realizing a moving image.

The OLED is a light-emitting display product that uses three types (red, green, and blue) of phosphor organic compounds having a self-luminous function, and uses a phenomenon in which electrons and positively charged particles injected from a cathode and an anode are combined with each other within an organic material to emit light by itself, so that there is no need for a backlight (a backlight device) that deteriorates color.

The light emitting diode (LED) panel, as a technology that uses one LED element as one pixel, may reduce a size of the LED element compared to the prior art, and thus, may implement the display module 150 that is bendable. A device referred to as an LED TV in the past only used the LED as the light source for the backlight unit that supplies the light to the LCD, and the LED itself was not able to constitute the screen.

The display module includes the display panel, and a coupling magnet, a first power supply, and a first signal module positioned on a rear surface of the display panel. The display panel may include a plurality of pixels R, G, and B. The plurality of pixels R, G, and B may be formed in respective areas where multiple data lines and multiple gate lines intersect each other. The plurality of pixels R, G, and B may be disposed or arranged in a matrix form.

For example, the plurality of pixels R, G, and B may include a red (hereinafter, ‘R’) sub-pixel, a green (‘G’) sub-pixel, and a blue (‘B’) sub-pixel. The plurality of pixels R, G, and B may further include a white (hereinafter, ‘W’) sub-pixel.

In the display module 150, a side on which the image is displayed may be referred to as a front side or a front surface. When the display module 150 displays the image, a side on which the image is not able to be observed may be referred to as a rear side or a rear surface.

In one example, the display module 150 may be constructed as the touch screen and may be used as the input device in addition to the output device.

The audio output unit 160 receives an audio-processed signal from the controller 180 and outputs the received signal as the audio.

An interface 170 serves as a passage for various types of external devices connected to the display device 100. The interface may be in a wireless scheme using the antenna as well as a wired scheme of transmitting and receiving data via the cable.

The interface 170 may include at least one of a wired/wireless headset port, an external charger port, a wired/wireless data port, a memory card port, a port for connecting a device having an identification module, an audio input/output (I/O) port, a video input/output (I/O) port, and an earphone port.

An example of the wireless scheme may include the broadcast receiver 1210 described above, and may include not only the broadcast signal, but also a mobile communication signal, a short-distance communication signal, a wireless Internet signal, and the like.

The external device interface 171 may transmit or receive data with a connected external device. To this end, the external device interface 171 may include an A/V input/output unit (not shown).

The external device interface 171 may be connected to the external device such as a digital versatile disk (DVD), a Blu-ray, a game console, a camera, a camcorder, a computer (a laptop), a set-top box, and the like in a wired/wireless manner, and may perform input/output operations with the external device.

In addition, the external device interface 171 may establish a communication network with various remote control devices 200 to receive a control signal related to the operation of the display device 100 from the remote control device 200 or to transmit data related to the operation of the display device 100 to the remote control device 200.

The external device interface 171 may include a wireless communication unit (not shown) for short-range wireless communication with other electronic devices. With such a wireless communication unit (not shown), the external device interface 171 may exchange data with an adjacent mobile terminal. In particular, the external device interface 171 may receive device information, running application information, an application image, and the like from the mobile terminal in a mirroring mode.

The network interface 172 may provide an interface for connecting the display device 100 to a wired/wireless network including an Internet network. For example, the network interface 172 may receive content or data provided by the Internet, a content provider, or a network operator via the network. In one example, the network interface 172 may include a communication module (not shown) for connection to the wired/wireless network.

The external device interface 171 and/or the network interface 172 may include a communication module for the short-range communication such as a wireless fidelity (Wi-Fi), a Bluetooth, a Bluetooth low energy (BLE), a Zigbee, and a near field communication (NFC), a communication module for cellular communication such as a long-term evolution (LTE), an LTE advance (LTE-A), a code division multiple access (CDMA), a wideband CDMA (WCDMA), a universal mobile telecommunications system (UMTS), and a wireless broadband (WiBro), and the like.

The user input interface 173 may transmit a signal input by the user to the controller 180 or transmit a signal from the controller 180 to the user. For example, a user input signal such as power ON/OFF, channel selection, screen setting, and the like may be transmitted/received to/from the remote control device 200, a user input signal input from a local key (not shown) such as a power key, a channel key, a volume key, a setting value, and the like may be transmitted to the controller 180, a user input signal input from a sensor unit (not shown) that senses a gesture of the user may be transmitted to the controller 180, or a signal from the controller 180 may be transmitted to the sensor unit.

The controller 180 may include at least one processor, and may control overall operations of the display device 100 using the processor included therein. In this regard, the processor may be a general processor such as a central processing unit (CPU). In one example, the processor may be a dedicated device such as an ASIC or a processor based on other hardware.

The controller 180 may demultiplex the stream input via the tuner 1211, the demodulator 1212, the external device interface 171, or the network interface 172, or process a demultiplexed signal to generate or output a signal for image or audio output.

The image signal image-processed by the controller 180 may be input to the display module 150 and displayed as an image corresponding to the corresponding image signal. In addition, the image signal image-processed by the controller 180 may be input to an external output device via the external device interface 171.

The audio signal processed by the controller 180 may be output as the audio via the audio output unit 160. In addition, the audio signal processed by the controller 180 may be input to the external output device via the external device interface 171. In addition, the controller 180 may include a demultiplexer, an image processor, and the like.

In addition, the controller 180 may control overall operations within the display device 100. For example, the controller 180 may control the tuner 1211 to select (tune) a broadcast corresponding to the channel selected by the user or the pre-stored channel.

In addition, the controller 180 may control the display device 100 in response to a user command input via the user input interface 173 or by an internal program. In one example, the controller 180 may control the display module 150 to display the image. In this regard, the image displayed on the display module 150 may be a still image or a moving image, and may be a 2D image or a 3D image.

In one example, the controller 180 may allow a predetermined 2D object to be displayed within the image displayed on the display module 150. For example, the object may be at least one of a connected web screen (a newspaper, a magazine, and the like), an electronic program guide (EPG), various menus, a widget, an icon, the still image, the moving image, and a text.

In one example, the controller 180 may modulate and/or demodulate a signal using an amplitude shift keying (ASK) scheme. Here, the amplitude shift keying (ASK) scheme may refer to a scheme of modulating the signal by varying an amplitude of a carrier wave based on a data value or restoring an analog signal to a digital data value based on to the amplitude of the carrier wave.

For example, the controller 180 may modulate the image signal using the amplitude shift keying (ASK) scheme and transmit the modulated image signal via a wireless communication module.

For example, the controller 180 may demodulate and process the image signal received via the wireless communication module using the amplitude shift keying (ASK) scheme.

Therefore, the display device 100 may easily transmit and receive a signal with another image display device disposed adjacent thereto without using a unique identifier such as a media access control address (MAC address) or a complex communication protocol such as TCP/IP.

In one example, the display device 100 may further include a photographing unit (not shown). The photographing unit may photograph the user. The photographing unit may be implemented with one camera, but may not be limited thereto, and may be implemented with a plurality of cameras. In one example, the photographing unit may be embedded in the display device 100 or disposed separately upwardly of the display module 150. Information on the image photographed by the photographing unit may be input to the controller 180.

The controller 180 may recognize a location of the user based on the image photographed by the photographing unit. For example, the controller 180 may identify a distance between the user and the display device 100 (a z-axis coordinate). In addition, the controller 180 may determine an x-axis coordinate and a y-axis coordinate within the display module 150 corresponding to the location of the user.

The controller 180 may sense the gesture of the user based on the image photographed by the photographing unit or the signal sensed by the sensor unit, or a combination thereof.

The power supply 190 may supply the corresponding power throughout the display device 100. In particular, the power may be supplied to the controller 180 that may be implemented in a form of a system on chip (SOC), the display module 150 for displaying the image, the audio output unit 160 for outputting the audio, and the like.

Specifically, the power supply 190 may include a converter (not shown) that converts AC power to DC power and a Dc/Dc converter (not shown) that converts a level of the DC power.

In one example, the power supply 190 serves to receive the power from the outside and distribute the power to each component. The power supply 190 may use a scheme of supplying the AC power in direct connection to an external power source, and may include a power supply 190 that may be charged and used by including a battery.

In a case of the former, the power supply is used in connection with the cable, and has difficulties in moving or is limited in a movement range. In a case of the latter, the movement is free, but a weight and a volume of the power supply increase as much as those of the battery, and the power supply must be directly connected to a power cable for a certain period of time for charging or coupled to a charging cradle (not shown) that supplies the power.

The charging cradle may be connected to the display device via a terminal exposed to the outside, or the built-in battery may be charged using a wireless scheme when approaching the charging cradle.

The remote control device 200 may transmit the user input to the user input interface 173. To this end, the remote control device 200 may use the Bluetooth, a radio frequency (RF) communication, an infrared radiation (IR) communication, an ultra-wideband (UWB), the ZigBee, or the like. In addition, the remote control device 200 may receive the image, audio, or data signal output from the user input interface 173 and display the same thereon or output the same as audio.

In one example, the display device 100 described above may be a fixed or mobile digital broadcast receiver that may receive a digital broadcast.

The block diagram of the display device 100 shown in FIG. 12 is only a block diagram for one embodiment of the present disclosure, and each component of the block diagram is able to be integrated, added, or omitted based on specifications of the display device 100 that is actually implemented.

That is, when necessary, two or more components may be combined to each other into one component, or one component may be subdivided into two or more components. In addition, functions performed in each block are for illustrating the embodiment of the present disclosure, and a specific operation or a device thereof does not limit the scope of rights of the present disclosure.

The new form-factor of the TV shown in FIGS. 1 to 12 above has an advantage in that the TV may be easily moved indoors.

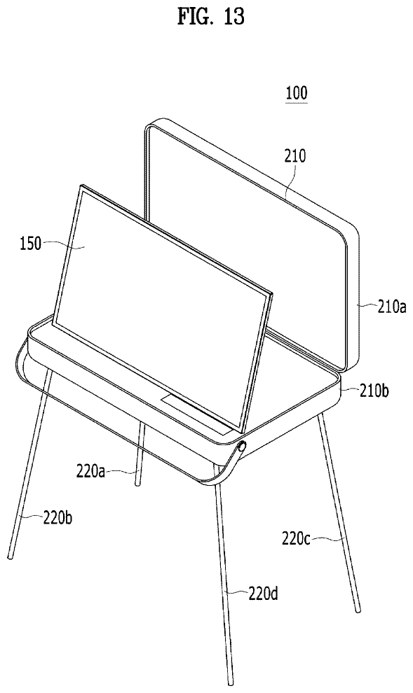

On the other hand, a new form-factor of the TV suitable for an outdoor long-distance movement, an outdoor camping site, or the like will be described in more detail with reference to FIGS. 13 to 16 below. In one example, designing some or all of the components shown in FIG. 12 to be included in a device shown in FIGS. 13 to 16 also belongs to another scope of rights of the present disclosure.

FIG. 13 is a diagram showing a display device according to an embodiment of the present disclosure. Hereinafter, redundant descriptions duplicate with the above descriptions will be omitted.

Referring to FIG. 13, the display device 100 has the display module 150 accommodated inside a housing 210. In this regard, the housing 210 may include an upper casing 210a and a lower casing 210b, and the upper casing 210a and the lower casing 210b may have a structure of being opened and closed.

In one embodiment, the audio output unit 160 may be included in the upper casing 210a of the display device 100, and the main board that is the controller 180, a power board, the power supply 190, the battery, the interface 170, the sensing unit 120, and the input unit (including the local key) 130 may be accommodated in the lower casing 210b. In this regard, the interface 170 may include a Wi-Fi module, a Bluetooth module, an NFC module, and the like for the communication with the external device, and the sensing unit 120 may include an illuminance sensor and an IR sensor.

In one embodiment, the display module 150 may include a DC-DC board, a sensor, and a low voltage differential signaling (LVDS) conversion board.

In addition, in one embodiment, the display device 100 may further include four detachable legs 220a, 220b, 220c, and 220d. In this regard, the four legs 220a, 220b, 220c, and 220d may be attached to the lower casing 210b to space the display device 100 from the floor.

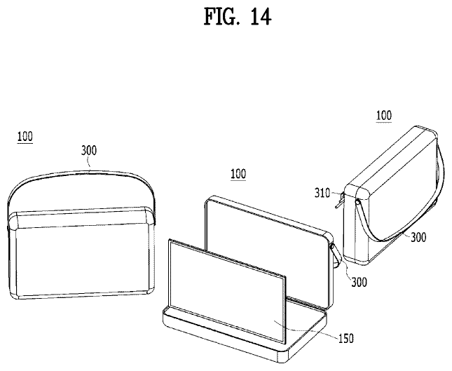

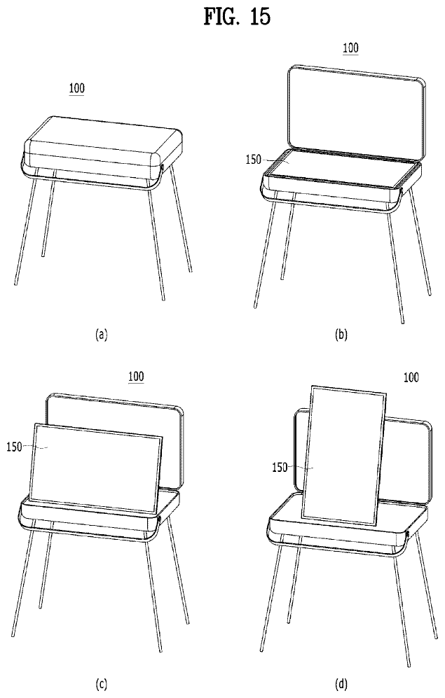

FIG. 14 is a diagram showing an example of utilization of a display device according to an embodiment of the present disclosure. Hereinafter, redundant descriptions duplicate with the above descriptions will be omitted.

In the embodiment of FIG. 14, the display device 100 represents an example of utilization that does not include the legs. Referring to FIG. 14, the display device 100 has the structure in which the display module is mounted in the upper casing and the lower casing as described above, and is able to be changed into a structure that may be carried like a bag when the upper casing and the lower casing are closed.

In one embodiment, the display device 100 may include a handle 300 on the upper casing or the lower casing. In this regard, the handle 300 may have a structure attached to left and right side surfaces of the upper casing or the lower casing such that the user may lift the housing with the closed upper casing and lower casing. In this regard, the handle 300 may be made of a material that is easy for the user to hold in the hand, such as leather or plastic.

That is, the display device 100 includes the handle 300 with the upper casing or the lower casing closed, so that the user may easily carry and move the display device 100.

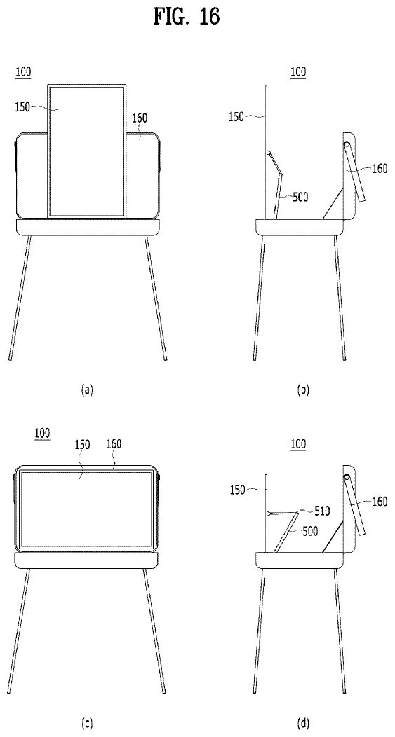

In addition, when necessary, the user may use the mounted display module 150 by placing the lower casing on the floor and opening the upper casing. This will be described in detail with reference to FIGS. 15 and 16.

In addition, in one embodiment, the display device 100 may further include an accommodating space 310 at the side surface of the lower casing. In this regard, the accommodating space 310 may include the various modules described above in FIG. 12. In addition, the accommodating space 310 may include a space for accommodating a touch-pen, a wireless earphone, or the like.

FIG. 15 is another diagram showing an example of utilization of a display device according to an embodiment of the present disclosure. Hereinafter, redundant descriptions duplicate with the above descriptions will be omitted.

In one embodiment of the present disclosure, the display device 100 may include four legs. In this regard, the four legs are attached to the lower casing to space the display device 100 from the floor.

Accordingly, the user may not only use the display device 100 while moving the same, but also use the same at a fixed location away from the floor.

(a) to (d) in FIG. 15 show an example of utilization in which the legs of the display device 100 are attached and the display device 100 is used at the fixed location. In this regard, (a) in FIG. 15 shows a state in which the upper casing of the display device 100 is closed, and (b) to (d) in FIG. 15 show a state in which the upper casing is opened.

Specifically, (b) in FIG. 15 shows a state in which the display module 150 is accommodated in the lower casing with the upper casing open. In other words, (b) in FIG. 15 shows a state in which the display module 150 lies inside the lower casing with the upper casing open. Even in the state in which the display module 150 is accommodated in the lower casing, the display module 150 may be activated.

In one embodiment, the display device 100 may provide an edit mode while the display module 150 is accommodated in the lower casing. In this regard, the edit mode may include a function of adding at least one of a memo function, a drawing function, and a voice recording function to a content.

That is, when the display module 150 is mounted on the lower casing, the display device 100 may determine that the user intends to appreciate/watch the content via the display module 150.

On the other hand, when the display module 150 is accommodated in the lower casing, the display device 100 may determine that the user intends to edit the content output on the display module 150. Accordingly, the display device 100 may provide a function of editing the content when the display module 150 is accommodated in the lower casing.

(c) in FIG. 15 shows a state in which the display module 150 is horizontally mounted on the lower casing with the upper casing open, and (d) in FIG. 15 shows a state in which the display module 150 is vertically mounted on the lower casing with the upper casing open. In this regard, (c) and (d) in FIG. 15 show a state in which the display module 150 is erected using the lower casing as a foothold.

In addition, in one embodiment, the display device 100 may automatically accommodate or mount the display module 150 in or on the lower casing using a motor (not shown).

More specifically, when the upper casing of the display device 100 is opened, the display module 150 may be automatically mounted horizontally or vertically on the lower casing.

In addition, in another embodiment, when the upper casing of the display device 100 is opened, the display module 150 may be primarily accommodated on the lower casing. Thereafter, the display device 100 may mount the display module 150 on the lower casing in response to a signal of touching the display module 150 and a signal input from the sensing unit or the input unit. For example, the user may mount the display module 150 on the lower casing by pressing the display module 150 accommodated inside the lower casing downwardly. This will be described in detail with reference to FIG. 16.

FIG. 16 is a diagram showing front and side surfaces of a display device according to an embodiment of the present disclosure. Hereinafter, redundant descriptions duplicate with the above descriptions will be omitted.

(a) and (b) in FIG. 16 show a state in which the display module 150 is mounted vertically, and (c) and (d) in FIG. 16 show a state in which the display module 150 is mounted horizontally.

(a) and (c) in FIG. 16 are views showing the display device 100 from the front, and (b) and (d) in FIG. 16 are views showing the display device 100 from the side.

In one embodiment, because the upper casing may include the audio output unit 160, in (a) in FIG. 16, the display module 150 may be mounted vertically and there may be the upper casing including the audio output unit 160 at the rear of the display module 150.

Referring to (b) in FIG. 16, the display device 100 may further include a support member 500 to vertically mount the display module 150 on the lower casing. That is, when the display device 100 is viewed from the side as shown in (b) in FIG. 16, the support member 500 may be included in the lower casing and may be designed in a foldable structure to vertically mount the display module 150. In this regard, the support member 500 may be controlled by the motor of the display device 100 and may be operated manually by the user's hand.

Referring to (c) in FIG. 16, the display device 100 may have the display module 150 mounted thereon horizontally and the audio output unit 160 at the rear of the display module 150.

Referring to (d) in FIG. 16, the display device 100 may include the support member 500 to horizontally mount the display module 150 on the lower casing. In this regard, the support member 500 may be the same as the support member 500 in (b) in FIG. 16, but may be in a state in which a hinge 510 included in the support member 500 is folded more to horizontally mount the display module 150.

In addition, in one embodiment, the display module 150 may be manually mounted horizontally or vertically by the user's hand. In another embodiment, the display module 150 may be mounted horizontally or vertically on the lower casing in response to the control of the display device 100. In this regard, the display device 100 may mount the display module 150 horizontally or vertically based on the control signal of the user (sensed via the sensing unit or the input unit).

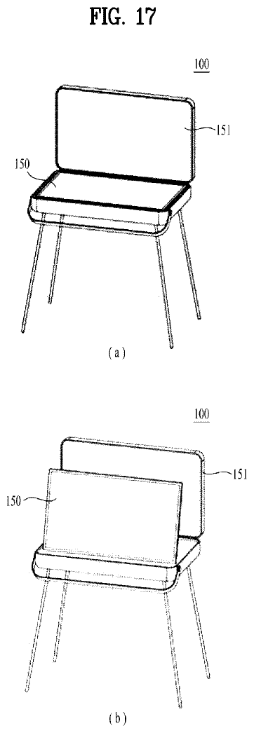

FIG. 17 illustrates a speaker mode and a video mode provided by a movable TV according to an embodiment of the present disclosure.

As illustrated in (a) in FIG. 17, in a TV 100 according to an embodiment of the present disclosure, the display module 150 may remain in a state parallel to the ground when a casing 151 is open. The state illustrated in (a) in FIG. 17 may be named as a speaker mode in the present disclosure.

In particular, in the speaker mode illustrated in (a) in FIG. 17, audio data such as music is output via a speaker, but the display module 150 remains in a turned-off state or only basic information related to music (e.g., a singer name, a song title, and the like) is displayed in a limited manner.

On the other hand, as illustrated in (b) in FIG. 17, in the TV 100 according to an embodiment of the present disclosure, the display module 150 may remain in a state nearly perpendicular to the ground when the casing 151 is open. The state illustrated in (b) in FIG. 17 may be named as a video mode in the present disclosure.

In particular, in the video mode illustrated in (b) in FIG. 17, video data such as a broadcast program is output, and it is similar to an operation of a regular TV. When a user mainly wants to watch videos, the video mode will be maintained.

Hereinafter, an embodiment of providing an easier connection process when a mobile device such as a smartphone or a tablet PC is to be connected to the movable TV will be described.

In addition, a solution for protecting the mobile device from an unexpected movement of the movable TV or the like when the movable TV and the mobile device come into physical contact with each other will be described below.

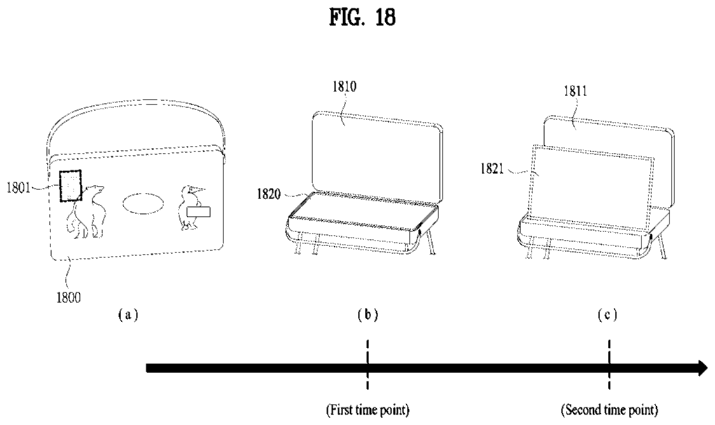

FIG. 18 illustrates a process in which a casing of a movable TV is automatically opened when a mobile device touches a first location, which is a specific location of the movable TV, according to an embodiment of the present disclosure.

A movable TV according to an embodiment of the present disclosure is located inside a casing 1800 as illustrated in (a) in FIG. 18, and includes a proximity sensor, particularly, at a first location 1801 of the casing 1800.

In this regard, the proximity sensor may be implemented, for example, using near field communication (NFC).

Therefore, it is available to recognize at least one mobile device by the proximity sensor attached to the first location 1801 of the casing 1800.

When the at least one mobile device is recognized, as illustrated in (b) in FIG. 18, it is designed that a state of a casing 1810 is changed to an open state but a location of a display module 1820 is not changed yet at a first time point.

However, when a second time point is reached after a certain period of time from the first time point, as illustrated in (c) in FIG. 18, a motor is controlled such that a display module 1821 and a casing 1811 face each other.

Therefore, from a perspective of the user, there is an advantage in that the TV casing is automatically opened simply by bringing the mobile device such as a mobile phone close to the specific location 1801 of the casing 1800. In other words, the TV is operated without using a separate TV remote control.

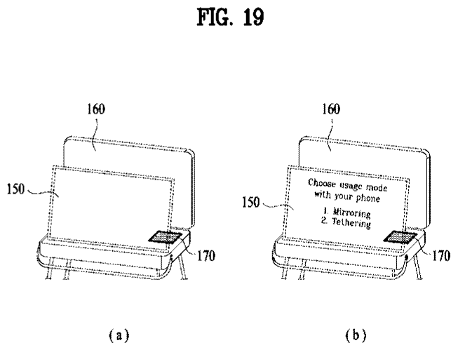

FIG. 19 illustrates a plurality of options provided by a movable TV when the movable TV according to an embodiment of the present disclosure and a mobile device come into contact with each other at a second location.

(a) in FIG. 19 assumes the state of (c) in FIG. 18. That is, a casing 160 of the movable TV is in an open state and is maintained in a state of being parallel to the display module 150 at approximately 180 degrees. For example, it corresponds to the video mode illustrated in (b) in FIG. 17.

In this regard, when the mobile device is placed at a second location 170 while the casing 160 is in the open state, the display module 150 of the TV outputs a message inquiring about a state of connection with the mobile device.

That is, when “No. 1. Mirroring” illustrated in (b) in FIG. 19 is selected, a screen of the mobile device is displayed identically to the display module 150 of the TV. On the other hand, when “No. 2. Tethering” illustrated in (b) in FIG. 19 is selected, the movable TV is designed to share Internet of the mobile device. With such design, there is an advantage that there is no need for complicated manipulation to connect the mobile device to the movable TV.

Furthermore, designing the mobile device placed at the second location 170 to be charged at the same time by placing a pad capable of charging at the second location 170 illustrated in FIG. 19 is another feature of the present disclosure. In one example, power for charging the mobile device is supplied from a battery of the movable TV.

Although not illustrated in FIGS. 18 and 19, designing to recommend an application used immediately before by referring to a previous usage history stored in a memory when the movable TV and the mobile device are reconnected to each other also falls within another scope of right of the present disclosure.

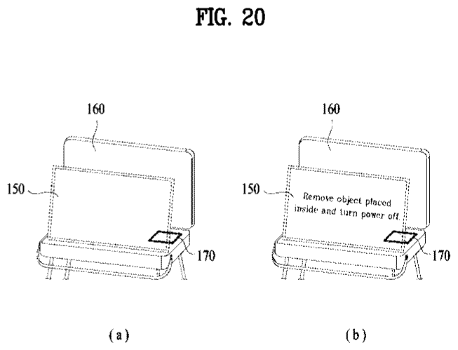

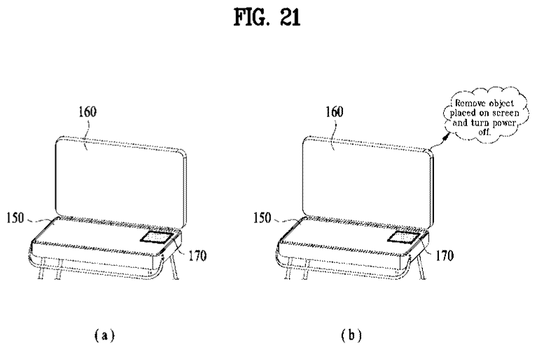

In addition, while FIGS. 18 and 19 mainly describe an embodiment that enhances convenience of connecting the movable TV with the mobile device, FIG. 20 and FIG. 21 below describe an embodiment that prevents damage reimbursement that may occur when the mobile device comes into physical contact with the movable TV.

FIG. 20 is a view for illustrating a process for processing a power-off signal when a mobile device is being charged while a movable TV according to an embodiment of the present disclosure is in a video mode.

As illustrated in (a) in FIG. 20, it is assumed that the TV is in the video mode. That is, it is assumed that a mobile device 170 is being charged via the battery of the movable TV while a casing 160 is opened and is parallel to the display module 150.

In this regard, when the power-off signal is received via the TV remote control or the like, the display module 150 and the casing 160 move toward the ground, and there is a possibility that the mobile device 170 being charged may be damaged.

Therefore, as illustrated in (b) in FIG. 20, when the power-off signal is received via the TV remote control or the like while the casing 160 is opened and is parallel to the display module 150 and the mobile device 170 is being charged via the TV battery, a lock for a motion of the casing 160 is set, and a guide message “Remove the object placed inside and turn the power off again” is output via the display module 150.

FIG. 21 is a view for illustrating a process of processing a power-off signal when a mobile device is mounted while a movable TV according to an embodiment of the present disclosure is in a speaker mode.

As shown in (a) in FIG. 21, it is assumed that the TV is in the speaker mode. That is, it is assumed that the casing 160 is open, but the display module 150 is parallel to the ground, and the mobile device 170 is mounted on top of the display module 150.

In this regard, when the power-off signal is received via the TV remote control or the like, the casing 160 moves toward the ground, and there is a possibility that the mobile device 170 mounted on top of the display module 150 may be damaged.

Therefore, when the power-off signal is received via the TV remote control or the like while the casing 160 is open, but the display module 150 is parallel to the ground, and the mobile device 170 is mounted on top of the display module 150 as illustrated in (b) in FIG. 21, the lock is set for the motion of the casing 160, and at this time, a guide voice “Remove the object placed on the screen and turn the power off again” is output via a speaker attached to the casing 160. Unlike in the embodiment illustrated in FIG. 20, in FIG. 21, it is designed that the guide voice is output via the speaker attached to the casing 160 instead of outputting the guide message on the display module 150. This is a design taking into account the fact that the user is likely not to recognize the guide message in a form of video because the mobile device 170 covers a portion of the display module 150.

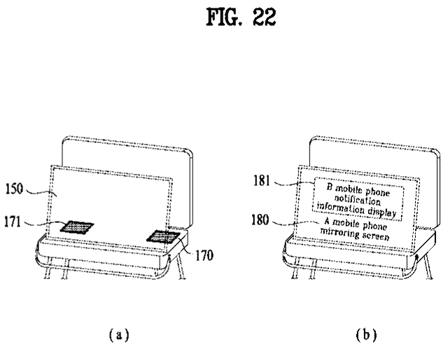

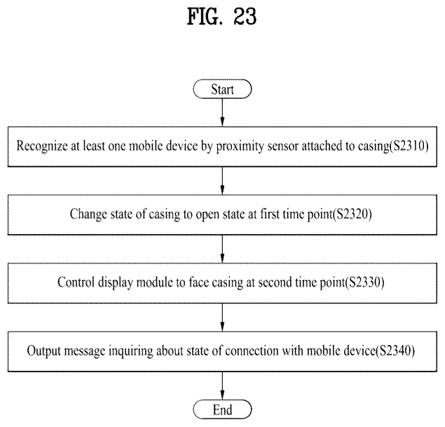

FIG. 22 is a view for illustrating a process of processing data received from mobile devices based on a priority or the like in a state in which a movable TV according to an embodiment of the present disclosure is in communication with the plurality of mobile devices.

The movable TV according to an embodiment of the present disclosure may be used in a camping site or the like where many people gather.

Therefore, as shown in (a) in FIG. 22, it may be assumed that the plurality of mobile devices, such as a first mobile device 170 and a second mobile device 171, are in communication with the TV.

In this regard, a problem arises as to which video data from a particular source should be output on the display module 150 of the movable TV. A solution for resolving such problem will be described with reference to (b) in FIG. 22.

That is, when there are the plurality of mobile devices connected to the movable TV via a communication network, a screen 180 the same as a screen of the first mobile device is output on the TV display module.

On the other hand, it is designed that a specific event that occurred in the second mobile device is output in a partial area 181 of the TV display module. Therefore, although it is not able to provide mirroring screens of all of the mobile devices on the TV, there is an advantage in that information (e.g., a social media notification or the like) of events that occurred in more mobile devices are able to be displayed on the TV.

In this regard, it is necessary to set a criterion for distinguishing between the first mobile device and the second mobile device mentioned above in advance. According to an embodiment of the present disclosure, priority may be assigned to the mobile devices in an order they are connected to the TV.

For example, when the first mobile device establishes the communication with the TV before the second mobile device, the priority is given to the first mobile device and the mirroring screen the same as the screen of the first mobile device is output on the TV.

According to another embodiment of the present disclosure, the priority may also be given based on remaining battery levels of the mobile devices.

For example, when a battery of the first mobile device is 50% consumed while a battery of the second mobile device is 70% consumed, the priority is given to the first mobile device and the mirroring screen the same as the screen of the first mobile device is output on the TV. The reason for designing as such is that there is a possibility that, when a mirroring service is provided with a mobile device with a relatively high battery consumption, the corresponding mobile device may be turned off.

Further, FIG. 23 is a flowchart illustrating a method for controlling a movable TV according to an embodiment of the present disclosure.

With reference to the previous drawings, the method for controlling the movable TV according to an embodiment of the present disclosure will be described.

The at least one mobile device is recognized by the proximity sensor attached to the casing of the movable TV (S2310). This has been described in detail in (a) in FIG. 18 above.

When the at least one mobile device is recognized, the state of the casing of the movable TV is changed to the open state at the first time point (S2320). This has been described in detail in (b) in FIG. 18 above.

Further, it is designed that the display module is controlled to face the casing at the second time point after the arbitrary time elapses from the first time point (S2330). This has been described in detail in (c) in FIG. 18 above.

Finally, the message inquiring about the state of connection with the at least one mobile device is output on the display module (S2340). This has been described in detail in FIG. 19 above.

In one example, when the method invention illustrated in FIG. 23 is implemented as a product invention, a TV that may be packaged by a casing includes a proximity sensor, a controller, a display module, and the like.

The proximity sensor (e.g., an NFC communication module) is attached to the casing of the movable TV and is designed to recognize the at least one mobile device.

The controller (e.g., a CPU or the like) changes the state of the casing to the open state at the first time point and controls the display module to face the casing at the second point in time when the at least one mobile device is recognized.

In particular, the controller controls the display module to output the message inquiring about the state of connection with the at least one mobile device, so that a technical effect of more quickly processing the network connection between the movable TV and the mobile device is expected.

The present disclosure described above may be implemented with computer-readable codes on a medium in which a program is recorded. Computer-readable media include all kinds of recording devices in which data readable by a computer system is stored. Examples of computer-readable media include a hard disk drive (HDD), a solid state disk (SSD), a silicon disk drive (SDD), a ROM, a RAM, a CD-ROM, a magnetic tape, a floppy disk, an optical data storage device, and the like, and also include those implemented in a form of a carrier wave (e.g., transmission over the Internet). In addition, the computer may include a controller. Accordingly, the above detailed description should not be construed as limiting in all respects and should be considered illustrative. The scope of the present disclosure should be determined by reasonable interpretation of the appended claims, and all changes within the equivalent scope of the present disclosure are included in the scope of the present disclosure.

### MODE

Various forms for carrying out the invention have been described above in the previous table of contents, Best Mode.

### INDUSTRIAL APPLICABILITY

The present disclosure is applicable to various types of movable TVs, and therefore, industrial applicability thereof is recognized.

What is claimed is:

1. A method for controlling a movable TV, the method comprising:
recognizing at least one mobile device by a proximity sensor attached to a casing;
changing a state of the casing to an open state at a first time point when the at least one mobile device is recognized;
controlling a display module to face the casing at a second time point; and
outputting a message inquiring about a state of connection with the at least one mobile device on the display module.

2. The method of claim 1, wherein the second time point arrives after the first time point,
a state of controlling the display module to face the casing includes a state having an angle formed by the display module and the casing of 180 degrees.

3. The method of claim 1, further comprising:
receiving a power-off signal while the at least one mobile device is being charged via the TV; and
setting a lock for a motion of the casing.

4. The method of claim 1, further comprising:
receiving a power-off signal while the at least one mobile device is in contact with the display module; and
outputting a guide voice via a speaker installed in the casing.

5. The method of claim 1, further comprising:
when the mobile device includes a plurality of mobile devices,
outputting a screen identical to a screen of a first mobile device on the display module; and
outputting only a specific event that occurred in a second mobile device on a partial area of the display module.

6. The method of claim 1, wherein the proximity sensor operates by near field communication (NFC).

7. A TV capable of being packaged by a casing, the TV comprising:
a proximity sensor attached to the casing and configured to recognize at least one mobile device;
a controller configured to change a state of the casing to an open state at a first time point and control a display module to face the casing at a second time point when the at least one mobile device is recognized; and
the display module,
wherein the controller is configured to control a message inquiring about a state of connection with the at least one mobile device to be output on the display module.

8. The TV of claim 7, wherein the second time point arrives after the first time point,
an angle formed by the display module and the casing at the second time point is 180 degrees.

9. The TV of claim 7, when receiving a power-off signal while the at least one mobile device is being charged via the TV, the controller is configured to set a lock for a motion of the casing.

10. The TV of claim 7, further comprising a speaker configured to output a guide voice when receiving a power-off signal while the at least one mobile device is in contact with the display module.

11. The TV of claim 7, when the mobile device includes a plurality of mobile devices, the controller is configured to:
control a screen identical to a screen of a first mobile device to be output on the display module; and
control only a specific event that occurred in a second mobile device to be output on a partial area of the display module.

12. The TV of claim 7, wherein the proximity sensor operates by near field communication (NFC).
